(19) United States
(12) Patent Application Publication
(10) Pub. No.: US 2003/0104151 A1
(43) Pub. Date: Jun. 5, 2003

(54) Printing face formulary

(76) Inventors: Ronald M. Buono, Flat Rock, NC (US); Joseph Carl Kalchbrenner, Greer, SC (US)

Correspondence Address: PENNIE & EDMONDS LLP, COUNSELLORS AT LAW, 1667 K Street, N.W., Washington, DC, 20006, US

(21) Appl. No.: 10/101,185

(22) Filed: Mar. 20, 2002

Related U.S. Application Data
(60) Provisional application No. 60/303,767, filed on Jul. 10, 2001.

(51) Int. Cl. B32B 1/08

(52) U.S. Cl. 428/36.91

(57) ABSTRACT

The present invention relates to a printing face layer for printing blankets which is the product of vulcanization of nitrile rubber with between 38% to about 45% by weight acrylonitrile; a particulate filler at between about 5 pph to about 50 pph; a coupling agent at a quantity of between about 0.5 to about 6 pph; at least one wettability modifier in an amount sufficient to increase the hydrophilicity of the printing face layer; a factice at about 5 to about 40 pph; sulfur at about 0.5 to about 3 pph; a primary accelerator at about 0.1 to about 4 pph; and zinc oxide at between about 2.5 to about 30 pph. Advantageously the printing face formulation also contains phenol formaldehyde resins, stabilizers such as antioxidants, UV protectors, antiozonants, and the like, and also includes resins and fatty acids.

### CROSS-REFERENCE TO RELATED APPLICATION

This application claims priority to U.S. Provisional Patent Application No. 60/303,767, filed Jul. 10, 2001, the entire disclosure of which is hereby incorporated by express reference hereto.

### FIELD OF THE INVENTION

The present invention relates to a replaceable sleeve which may be readily mounted onto a cylindrical carrier, for example a replaceable sleeve comprising a multilayer reinforced composite. More particularly, this invention relates to a printing face rubber formulation for a printing blanket by a material spray process.

### BACKGROUND OF THE INVENTION

Rubber-covered cylindrical rollers are widely used in industry for a number of applications, particularly for web or sheet handling and processing applications such as the embossing, calendering, laminating, printing and coating of paper, film, foil, and other materials. In addition to their use in web processing equipment, such rubber-covered rollers are often employed in conveyors and various office machines. Such rollers are typically comprised of a cylindrical (metal) core or other support with an outer covering of rubber, elastomer, or polymer material. However, after extended use, the covering on the rollers wears down and must be resurfaced or replaced. This typically requires that the rollers be sent to an outside source where the old surface is ground down and a new surface is applied. This is inconvenient and expensive as it requires that the processing equipment be shut down while the roller is being resurfaced or that the end user stock additional replacement rollers.

Cylindrical rollers are widely used in the printing industry. For example, printing rollers or sleeves are used in the flexographic printing industry and in the offset printing industry for providing a mountable surface for flexographic printing plates or offset printing blankets. In a typical flexographic printing press, the sleeve is mounted onto a printing cylinder using pressurized air to expand the sleeve, and the printing plates are then attached to the outer surface of the sleeve. In an offset printing process, the blanket is mounted onto a printing cylinder using pressurized air to expand the blanket.

The prior art for preparing a compressible layer for a printing blanket, as discussed in U.S. Pat. No. 5,553,541, utilizes threads as a carrier for the rubber composition and the entrapped microcells. Microspheres from are available commercially from EXPANCEL Inc., an AKZO NOBEL Co., Duluth, Ga., U.S.A. The prior art manufacture of seamless gapless printing blankets involves the coating of thread to form a microcellular elastomeric layer known as the compressible layer. The elastomer consisting of a nitrile-butadiene copolymer has been used in this layer. The compressible or cushion layer functions to provide energy absorption, and resiliency to the blanket while allowing strain deformations to occur in the radial direction with little to no Poisson's effect occurring at the printing interface to kept the printing within the required specs.

The thickness of the compressible layer is determined by the coating of threads of different thicknesses. The threads act as a carrier for the compressible microcellular rubber formulation, and form a partially inelastic layer of different physical characteristics than the remaining portion of the layers in the blanket. The threads are wound under tension, and the deposited layer typically stratifies to a thread-rich inner portion and a thread-poor outer portion. The use of threads is expensive and time consuming. Additionally, the presence of threads close below the face layer of the printing blanket may cause print imperfections due to a variation in pressure points. The apex of the threads applies more pressure to the printed surface then the area where two threads meet and adjoin each other.

Typically in blankets, high to medium levels of fillers and blends of fillers have been used. Typically these are low to non-reinforcing in nature. The rubber composition typically comprises polysulfide rubber. For cure systems, conventional systems are used as defined in “The Vanderbilt Rubber Handbook”. Typically the over all recipes resemble the recipes, which can be found in the section on Sponge Rubber found in “The Vanderbilt Rubber Handbook”, medium to highly loaded with non-reinforcing fillers and conventional cure systems. Such rubber compositions have poor wearability and strength.

The introduction of the Sunday Press by Heidelberg M-3000 TM has challenged the printing face prior art by providing operational conditions, which exist outside the experience envelop of the printing face chemistry used on the traditional Flat Blankets. The higher web speeds and the thinner blanket design have challenged the performance of the traditional formulary chemistry used as printing faces on blankets.

A typical formulary for printing faces consists of THIOKOL polysulfides at 5-40 pph, Nitrile (29-34% acrylonitrile) at 95-60 pph, silica, for example PPG HISIL 233 (TM) at 5-50 pph, processing oil at 2-10 pph, a sulfur cure agent at 0-3 pph, an accelerator at 0-4 pph, a secondary accelerator (Thiuram or Carbamate) at 0-3 pph, and an activator, for example zinc oxide/fatty acid at 1-5 pph. Any of the above groups can be found listed in the recognized Industry reference “The Vanderbilt Rubber Handbook” Thirteenth Edition.

The challenge to the above chemistry is lack of sufficient cure state and density to withstand the high-speed dynamic operational conditions, and the surface chemistry of the materials used which, do not address the physical demands of the fountain solution and ink combination which the blanket is transferring during the high speed operation. These challenges show up in various printing conditions, which are disadvantageous to acceptable commercial print product.

### SUMMARY OF THE IWENTION

The invention consists of a printing blanket comprising a sleeve, a compressible layer including a open or closed-cell polymeric foam, and a printing face layer, wherein the printing face layer comprises a base of 100 parts of nitrile with between about 35% to about 50% by weight acrylonitrile content, about 5 to about 50 pph of silica, about 0.1 to about 15 pph of a coupling agent, about 5 to about 60 pph of a processing oil, at least about 0.1 pph of a sulfur-based curing agent, about 1 to about 20 pph metal oxide.

In a preferred embodiment the printing blanket further comprises between about 1 to about 10 pph of a fatty acid and between about 1 to 10 pph zinc oxide, and the metal oxide comprises TiO₂, MgO, CaO, or a mixture thereof. The processing oil may comprise polyester phthalate. The nitrile beneficially comprises 36% to about 45 % by weight acrylonitrile. Advantageously, the silica when admixed with an equal volume of deionized water imparts a pH of between about 9 to about 11 to the water, and wherein the quantity of silica is between about 15 pph to about 25 pph.

Even more advantageously, the nitrile consists of between about 39% to about 41% by weight acrylonitrile content. The coupling agent may comprise an organosilane compound.

In a further embodiment, the processing oil is present in an amount between about 15 to about 25 pph and the coupling agent is present in an amount between about 3 to about 5 pph.

The sulfur-based curing agent may comprise between about 0.1 to about 3 pph of sulfur, between about 0.1 to about 4 pph of a primary accelerator, and between about 0.1 to about 3 pph of a secondary accelerator.

Additionally, the total quantity of zinc oxide and fatty acid or salt thereof is advantageously between about 5 to about 8 pph.

Further, in one embodiment, in the printing layer composition composes between about 1 pph to about 8 pph of an antioxidant, an antiozonant, or a mixture thereof.

The layer contains between about 0.1 pph to about 20 pph of a halogenated compound in the printing layer.

In an additional embodiment, the halogenated compound comprises a fluorosurfactant in an amount sufficient to increase the hydrophilicity of the printing layer. The halogenated compound may be a fluorinated polyethylene glycol.

In another of the preferred embodiments, the printing blanket layer swells less than about 40% when immersed in toluene for 60 minutes at ambient conditions.

Further, the printing face layer has a tensile strength greater than about 600 psi and the elongation at break is greater than 250%. A preferred printing face layer has a tensile strength greater than about 1000 psi and the elongation at break is greater than 400%.

In an additional embodiment, the compressible layer and the printing layer are substantially free of wound thread in the printing area.

In another embodiment, the compressible comprises a nitrile-butadiene copolymer, hydrogenated nitrile-butadiene copolymer, carboxylated nitrile-butadiene copolymer, nitrile-butadiene-isoprene terpolymer, neoprene, isoprene, epoxidized isoprene, or mixtures thereof, an aromatic oil at a rate of between about 5 pph and 30 pph, carbon black, and a sulfur-based curing agent.

The one or more elastomeric rubbers useful in the present invention can include, but are not limited to: natural rubber, polyisoprene rubbers, polyisobutylene rubbers, polybutadiene rubbers, chloroprene rubbers (e.g., such as those commercially available under the tradename NEOPRENE from DuPont Chemical), nitrile rubbers (e.g., such as acrylonitrile-butadiene copolymers, or NBRs, commercially available under the tradename NIPOL from Zeon Chemicals Inc. or under the tradename PARACRIL from Uniroyal), butyl rubbers, silicone rubbers, fluorinated rubbers (e.g., such as those commercially available under the tradename VITON from DuPont Chemical), polysulfides (e.g., such as those commercially available under the tradename THIOKOL from Rohm & Haas), copolymer rubbers (e.g., random, alternating, block, multiblock, graft, multigraft, comb, star, branched, and/or dendritic copolymers comprising at least one of ethylene, propylene, butadiene, isoprene, styrene, isobutylene, and the like, filly or partially hydrogenated versions thereof, or a combination thereof, which may include, but are not limited to, EPDM, EPR, SBR, SBS, SIS, SEBS, SEPS, SEEPS, or combinations thereof), and the like, as well as mixtures or copolymers thereof. In one preferred embodiment, the one or more elastomeric rubbers comprises a nitrile rubber. In another preferred embodiment, the one or more elastomeric rubbers consists essentially of one or more nitrile rubbers.

The one or more additives and/or processing aids useful in the invention may include, but are not limited to:

organic or inorganic low molecular weight fillers and/or reinforcing agents (e.g., clay; talc; glass fibers; mica; calcium metasilicate; barium sulfate; zinc sulfide; lithopone; silicates; silicon carbide; diatomaceous earth; carbonates such as calcium carbonate and magnesium carbonate; silica such as that commercially available under the tradename HISIL from PPG Industries; particulate carbonaceous materials such as graphite, carbon black (e.g., commercially available from Cabot), cotton flock, natural bitumen, and cellulose flock; micro balloons such as glass and ceramic; fly ash; or the like; or combinations thereof), preferably silica and/or carbon black, more preferably, where carbon black is used, a mixture of grades may be used, but preferably a single grade of carbon black is used, more preferably the Cabot N550 grade of carbon black;

tackifying additives (e.g. , wood resins, such as coumarene-indene, lignin resin, and/or those commercially available under the tradename FF from Hercules);

phenol-formaldehyde resins, such as those commercially available under the tradename P-87 from Akrochem; and the like, or combinations thereof);

homogenization agents (e.g., plasticizing organic oils, such as those aromatic oils commercially available under the tradename SUNDEX from Sun, di(butoxy-ethoxy-ethyl) formal, which is available under the tradename TP-90B from Rohm & Haas, or the like, or a mixture thereof;

oligomeric/polymeric oils, such as polyester phthalate, which is available commercially under the tradename PLASTHALL from CP Hall, mixed phthalate oils, such as those commercially available under the tradename PALANTIOL from BASF, or the like, or a mixture thereof; or the like; or a combination thereof);

formability enhancers (e.g., factices or vulcanized oils, such as crosslinked vegetable oil, which can be obtained commercially under the tradename RHENOPRENE from Bayer);

reaction controlling compounds (e.g., retarding agents, such as those commercially available under the tradename PVI from Vanderbilt);

pigments (e.g., white pigments, such as (rutile) titania which is commercially available from DuPont or, in combination with nitrile rubber, from Polymerics; blue pigments, such as 12973 Blue, which is commercially available from Harwick; and the like; or combinations thereof);

surface active compounds (e.g., silane compounds, such as organosilanes commercially available, inter alia, from Degussa);

and the like; or a mixture thereof.

The crosslinking agent according to the invention may include one or more compounds that facilitate the crosslinking/vulcanization of the elastomeric rubber component and may advantageously include, but is not limited to:

accelerators (for example, organic sulfur-containing compounds, such as sulfenamides, e.g., mercapto-benzothiazole sulfenamide or N-tert-butylbenzothiazole sulfenamide, which are both commercially available, in combination with EPR, under the tradename RHENOGRAN from Rhein Chemie; tetraethylthiuram, which is commercially available under the tradename TETD from Akrochem; tetramethylthiuram, which is commercially available under the tradename TMTD from Akrochem; carbamide compounds, such as those commercially available under the tradename BUTYL-8; dithiodimorpholine, which is commercially available under the tradename VANAX from Vanderbilt; or the like; or a combination thereof);

activators (e.g., zinc oxide, which is commercially available, in combination with EPR, under the tradename RHENOGRAN from Kenrich; magnesium oxide, which is commercially available under the tradename MAGLITE from CP Hall and which is also useful to alter the hydrophilicity of the composition; polyethylene glycol, such as that commercially available under the tradename CARBOWAX from Union Carbide, and which is also useful to alter the hydrophilicity of the composition; or the like; or combinations thereof);

sulfur compounds (e.g., elemental sulfur or other sulfur source, such as P-80, which is commercially available from Akrochem, in combination with SBR; SPIDER SULFUR, which is commercially available from Akrochem; or the like; or a combination thereof);

acidic dispersants (e.g., organic fatty acids having a number average molecular weight below about 500, such as stearic acid or the like);

or the like; or a combination thereof.

The one or more antioxidants may include, but are not limited to, one or more of the following, or combinations thereof:

(i) Phenol and/or alkylated monophenols;

(ii) Hydroquinones and/or alkylated hydroquinones;

(iii) Tocopherols;

(iv) Hydroxylated thiodiphenyl ethers;

(v) Bisphenol and/or alkylidenebisphenols;

(vii) O—, -and S-benzyl compounds;

(vii) Hydroxybenzylate malonates;

(viii) Aromatic hydroxybenzyl compounds;

(ix) Triazine compounds;

(x) Benzylphosphonates;

(xi) Acylaminophenols;

(xii) Ascorbic acid (Vitamin C);

(xiii) Aminic antioxidants such as hydroquinoline; phenylenediamine; and/or derivatives or mixtures thereof;

(xiv) UV-absorbers and light stabilizers;

(xv) Phosphites and phosphonites;

(xvi) Hydroxylamines;

(xvii) Thiosynergists such as dilauryl thiodipropionate, distearyl thiodipropionate, and mixtures thereof;

(xviii) Peroxide scavengers such as esters of thiodipropionic acid, for example the lauryl, stearyl, myristyl or tridecyl esters; mercaptobenzimidazole or the zinc salt of 2-5 mercaptobenzimidazole; zinc 2-mercapto-toluimidazole; zinc dibutyldithiocarbamate;

dioctadecyl disulfide; pentaerythritol tetrakis(-dodecylmercapto)propionate; and

mixtures thereof;

or mixtures thereof.

In a preferred embodiment, the at least one antioxidant is selected from the group consisting of zinc 2-mercapto-toluimidazole, bis-phenol, phenol, phenylenediamine, hydroquinoline, and any combination thereof.

### DESCRIPTION OF THE PREFERRED EMBODIMENTS

The present invention is related to several other co-pending applications, namely U.S. Patent Application No. ______entitled “Printing Blanket Face and Compressible Layer Compositions,” filed on even date herewith and itself claiming priority to U.S. Provisional Patent Application No. 60/303,818, filed Jul. 10, 2001; U.S. Patent Application No. ______, entitled “Polymeric Sleeve Used in Printing Blanket,” filed on even date herewith and itself claiming priority to U.S. Provisional Patent Application No. 60/303,804, filed Jul. 10, 2001; and U.S. Patent Application No. ______, entitled “Spray Coating Method of Producing Printing Blankets,” filed on even date herewith and itself claiming priority to U.S. Provisional Patent Application No. 60/303,803, filed Jul. 10, 2001, each of the entire disclosures of which are hereby incorporated herein by express reference hereto.

The invention relates to forming a printing blanket by applying on a primed sleeve a compressible layer and/or a reinforcing layer, and a printing face layer. The invention more particularly relates to new rubber formulations for one or more of the aforesaid layers.

The compressible layer may comprise of an open or closed-cell polymeric foam. The cell structure of the foam, may be created with suitable chemical blowing agents such as magnesium sulfate, hydrated salts, hydrazides such as p-toluene sulfonyl hydrazide and p,p-oxybisbenzene sulfonyl hydrazide, and carbonamides such as 1,1′-azobisformamide, nitrate, nitrite, bicarbonate and carbonate salts. Still another preferred method of forming the compressible layer includes the incorporation of microcapsules.

The other ingredients to the rubber formula such as reinforcing fillers, processing oils, and cross-linking systems all are integral in providing the final physical performance properties of the mixture as it is cured into it's final form as a product. Prior art consists of blended carbon black grades. Blends of fillers, specifically carbon blacks, is not recommended. Without being bound to theory, it is believed that there is negative synergy between multiple filler components.

The compressible layer rubber compound for printing blankets of the present invention provide high strength and low heat generation that are key to longevity of the performance.

In one embodiment, this compressible layer comprises a composition formed from a nitrile-butadiene copolymer, hydrogenated nitrile-butadiene copolymer, carboxylated nitrile-butadiene copolymer, nitrile-butadiene- isoprene terpolymers, neoprene, isoprene, epoxidized isoprene, SBR, or any of the polyurethane elastomeric rubbers, or blends of such. The cell structure of the compressible layer may be created with suitable chemical blowing agents such as magnesium sulfate, hydrated salts, hydrazides such as p-toluene sulfonyl hydrazide and p,poxybisbenzene sulfonyl hydrazide, and carbonamides such as 1,1′-azobisformamide, nitrate, nitrite, bicarbonate and carbonate salts. Still another preferred method of forming the compressible layer includes the incorporation of microcapsules, for example microcells.

In another embodiment, a compressible layer is applied to a sleeve and a reinforcing layer comprising a threaded or non-thread polymeric layer consisting of a nitrile-butadiene copolymer, hydrogenated nitrile-butadiene copolymer, carboxylated nitrile-butadiene copolymer, nitrile-butadiene- isoprene terpolymers, neoprene, isoprene, epoxidized isoprene, SBR, or any of the polyurethane elastomeric rubbers, or blends of such, is applied by spreading, spraying, or extruding over the compressible layer. The reinforcing layer is designed in composition, via polymeric composition or reduction in cell density versus the compressible layer, to posses physical properties of higher hardness, static modulus, dynamic modulus as compared to the compressible layer. The compressible layer benefits from and is structurally strengthened by the addition of the reinforcing layer. Like the compressible layer, the solvated polymeric and/or rubber components and any fillers are applied to the printing blanket by electrostatic or conventional spraying.

In one embodiment the rubber compound comprises Butadiene, Isoprene, an acrylonitrile-butadiene-isoprene terpolymer, or a mixture thereof. The butadiene and/or isoprene can be in the form of a copolymer or terpolymer, which may be either random or block. A preferred embodiment comprises at least 30%, more preferably at least 60%, of the acrylonitrile-butadiene-isoprene terpolymer, beneficially admixed with butadiene or copolymer thereof, isoprene or copolymer thereof, or a mixture thereof. The acrylonitrile content of the terpolymer provides oil and solvent resistance. A preferred acrylonitrile-butadiene-isoprene terpolymer is DN1201 (TM) available commercially from Zeon.

In another preferred embodiment, the compressible layer comprises isoprene, an acrylonitrile-isoprene copolymer or acrylonitrile-isoprene-X terpolymer where X is another monomer.

Other components and additives are beneficially added to the composition. For example, oils, preferably aromatic oils which are at least partially polymerized into the composition during processing, are beneficially added at a rate of between about 5 pph and 30 pph, preferably at a rate of between about 15 pph and about 20 pph. Resins, for example wood resins, are beneficially added at a rate of between about 1 pph and about 20 pph, preferably at a rate of between about 5 pph and about 10 pph. Modifiers, for example fatty acids or their salts, i.e., stearic acid or zinc stearate, are beneficially added at between about 0.1 pph to about 10 pph, preferably between about 0.5 pph to about 3 pph. Additional zinc, or other crosslinking agent, can be added at a rate of between about 2 pph and about 15 pph, for example between about 6 pph and about 10 pph. Sulfur and sulfur-containing curing agents are added as needed, for example at a rate of between about 1 pph to about 8 pph. Pph means parts by weight in 100 parts of the base polymer(s).

The filler can be any type normally used in the art. A preferred filler comprises reinforcing carbon black fillers which have particle size as measured by the Iodine # of 20 to 100, preferred 30 to 60, more preferred 40 to 50, to provide a balance between abrasion resistance and heat build-up. The structure of the reinforcing carbon black as measured by the DBP # for best performance will be about 50 to about 150, preferred about 80 to 130, more preferred 105 to 125, to provide the best balance between tear resistance and modulus. The loading or percent of filler in the total recipe should be between about 8 to about 70 phr, preferably between about 13 to about 50 pph, more preferably about 15 pph to about 37 pph, for example about 22 pph..

The cure system can include any cure system known to one of skill in the art, such as those described in “An Efficient Vulcanization System” by “The Vanderbilt Rubber Handbook”. Preferably the cure system produces a predominance, i.e., greater than 50%, preferably greater than 70%, of mono and disulfide crosslinks which have greater thermal and mechanical stability than polysulfide crosslinks which are produced by conventional sulfur cures.

The preferred formulation, when tested according to ASTM D623 to the “Blowout Condition” on a Goodrich Flexometer (TM) will provide a result of 30 minutes minimum, preferably 45 minutes minimum, more preferably 60 minutes minimum.

In one embodiment, the cure system contains: sulfur at 0.1 to 3 pph, preferably 1 to 2 pph; a primary accelerator (Dithiodimorpholine, Thiazole or Sulfenamide) at 0 to 4 pph, preferably 1.5 to 3.5 pph; and a secondary accelerator (Thiuram or Carbamate) at 0 to 3 pph, preferably 1 to 2 pph.

The preferred cure system would be considered a semi-EV system where some polysulfide crosslinks are desired to improve tear strength, adhesion, and modulus due to low levels of reinforcing filler. A lower loading of reinforcing filler is desired to reduce the heat generation, which occurs during repeated flexing or repeated compression.

Another aspect of the invention includes the addition of antioxidants and antiozonants at levels of 1 to 9 pph, preferred 1.5 to 6 pph, more preferred 2 to 4 pph, for the stabilization of the physical properties and performance over time.

The inner compressible layer and intermediate reinforcing layer can also include butyl rubber, nitrile rubber, EPDM rubber, natural rubber, synthetic rubber, neoprene rubber, polysulfide rubber, a blend of nitrile rubber and polyvinyl chloride, polyurethane, and mixtures thereof. Preferably these compounds together comprise less than 50 percent by weight of the base polymer, more preferably less than about 20% of the base polymer.

The compressible layer is placed on a blanket including but not limited to cylinders, tubes, flat blankets, blankets used for flexographic printing blankets, and liners. The replaceable blanket is made up of a combination of layers including an inner sleeve, optionally a reinforcing layer overlying the inner sleeve, an intermediate compressible polymeric layer overlying sleeve/reinforcing layer, optionally a reinforcing layer overlying the compressible layer, and an outer polymeric layer forming a working, i.e., printing, surface.

The inner sleeve can be either metallic or non-metallic, i.e., polymeric. While thin metal sleeves for use on printing cylinders have been employed in the past, more recently, printing sleeves have been developed which are comprised of polymeric materials. For example, printing sleeves are known which include laminated polymeric layers reinforced with a woven or nonwoven fabric layer. Such sleeves provide an advantage over metal rollers in that they are readily expandable for mounting on a cylinder, are seamless, and provide good structural integrity for printing operations without the damage and safety limitations of thin metal sleeves. The sleeve may have a reinforcing layer, and may have a coating or layer on the internal diameter to provide the desired friction or holding strength to the roller. The sleeve can be either a sleeve, a primed sleeve, or a sleeve with one or more coatings affixed thereto.

The compressible or cushion layer functions to provide energy absorption and resiliency to the blanket while allowing strain deformations to occur in the radial direction with little to no Poisson's effect occurring at the printing interface. This radial compressibility is needed to keep the printing within the required specs. The compressible layer may comprise of an open or closed-cell polymeric foam. One method of incorporating cells is by adding expanded and/or expandable microspheres. The number of microspheres in the rubber composition can range from about 1% to 10%, preferably from about 1.5% to about 4%.

Advantageously, the uncured rubber may also be formulated to contain unexpanded microspheres, pre-expanded microspheres, or a combination thereof for the compressible layer spray formulation. Such microspheres are subject to undesired degradation by solvents used to liquify the rubber composition. One preferred embodiment uses a solvent Methyl Isobutyl Ketone, MIBK. In another embodiment the solvent comprises a mixture of Toluene, Ethyl Acetate and a Ketone. Of course, any polar organic solvent which is capable of solvating the rubber composition and which does not unduly attack microsphere can be used, especially in combination with MIBK and/or methyl amyl ketone.

The rubber of the present composition can be placed on the sleeve by thread transfer, spraying, electrostatic spraying, extrusion, substantially solventless extrusion, spread with a doctor blade or spreader, spread with rollers, or the like.

A printing face layer is applied over the compressible layer and reinforcing layer, if any. The printing face may include a closed-cell foam or solid density or mixture thereof. The printing face may include a nitrile-butadiene copolymer, a hydrogenated nitrile-butadiene copolymer, a carboxylated nitrile-butadiene copolymer, a nitrile-butadiene- isoprene terpolymers, neoprene, isoprene, epoxidized isoprene, SBR, EPDM, butyl, halogenated butyl, fluoroelastomers, or any of the polyurethane elastomeric rubbers, or blends thereof. One acceptable polymer is DN4050 available from Zeon.

The printing face composition may also include fillers, wettability modifiers, basicity modifiers, crosslinkers, and the like. The solvated rubber composition may optionally include a binder capable of forming a bond with one or more particulate fillers such as barite, silica, carbon black, polysulfide rubber, microcells, and the like, such as carboxylated styrene butadiene latex, styrene-acrylic copolymer latex, acrylic latex, vinyl acrylic latex, urethane (aromatic and aliphatic), diphenylmethane diisocyanate-urethane (MDI), and toluene diisocyanate (TDI).

One aspect of the invention is a new printing face composition comprising:

a base of 100 parts of nitrile with between about 35% to about 50% by weight acrylonitrile, preferably with about 36% to about 45%by weight acrylonitrile, more preferred 39% to 41% by weight acrylonitrile;

silica, for example commodity grade, preferably with pH in caustic range, i.e., pH >7, preferably pH is between 9 to 11, more preferably between 9.5-10.5, at 5 to 50 pph, preferably between about 15 pph to about 25 pph;

an coupling agent, i.e., an organosilane coupling agent at a quantity of between about 0. 1-15 pph, preferably between about 3 to about 5 pph;

an aromatic oil with a high number of hydroxyl groups, for example polyester phthalate processing oil such as is commercially available from C.P. Hall of Chicago as P-900 (TM) at a rate of about 5 to about 60 pph, more preferably between about 15 to about 25 pph, for example 20 pph;

sulfur at about 0 to about 3 pph, preferably between about 0.1 to about 3 pph, more preferably between about 1.2 to about 2.2 pph;

advantageously a primary accelerator, i.e., Dithiodimorpholine, Thiazole and/or Sulfonamide at a rate of between about 0.1 to about 4 pph, preferably between about 1.5 pph to about 3 pph;

advantageously a secondary accelerator, i.e., Thiuram or Carbamate, at a rate of between about 0.1 to about 3 pph, more preferably between about 0.25 to about 1.5 pph;

an activator, i.e., zinc oxide/fatty acid combination or a zinc or other metal salt of a fatty acid, at a rate of between about 1 to about 10 pph, preferably at a rate of between about 5 to about 8 pph;

advantageously other metal oxides, for example TiO2, MgO, and/or CaO, at a rate of between about 1 to about 20 pph, preferably at a rate of between about 5 to about 12 pph; and

advantageously an antioxidant/antiozonant at a rate of between about 1 pph to about 8 pph, preferably between about 2 to about 5 pph.

Advantageously, the metal oxides both assist in crosslinking and increase hydrophillic behavior.

Advantageously, a factice, for example a crosslinked vegetable oil, is added in an amount ranging from about 3 pph to about 40 pph, preferably between about 15 pph to about 25 pph, to assist in processing and to improve physical properties of the crosslinked composition.

The nitrile used in prior art blankets has between about 30% to about 33% acrylonitrile. The inventors unexpectedly found that by increasing the acrylonitrile content of the nitrile to about 38% or more, the composition had oil and solvent resistance and release characteristics better than a polysulfide-containing blanket.

A coupling agent, for example an agent which links the polymeric backbone to the filler, is advantageously included. This coupling agent allows the inorganic filler to contribute to the strength and tear resistance of the composition. The coupling agent can be an organosilane. Advantageously this coupling agent is added at an amount equal to about 0.05 to about 0.25 times the amount of silica added to the composition.

In a preferred embodiment a halogenated compound, for example a halogenated prepolymer, for example a fluorosurfactant, i.e., Zonyl (TM) from DuPont, Lodyne (TM) from Ciba, Bayowet (TM) from Bayer, is added to the above formulation in an amount sufficient to increase the hydrophilicity of the composition, for example at a rate of between about 0.1 pph to about 20 pph, more preferably between about 3 pph to about 8 pph. A preferred fluorosurfactant is a fluorinated polyethylene glycol.

In another embodiment, surfactant monomers or prepolymers, for example carboxylates, i.e., itaconic acid or (meth)acrylic acids, sulfonates, for example p-sulfophenyl methallyl ether, allyl sulfonates, styrene sulfonates, ethylene carbonate, dimethylsulfoxide, and the like can be added to the composition in an amount between about 0.1 to about 3 pph. These surfactant monomers will make the composition more hydrophillic.

In yet another embodiment, a hydrophillic polymer can be added to the formulation to increase hydrophilicity. A preferred hydrophilic polymer would have a molecular weight of at least about 800 and have at least one available oxygen or hydroxyl functional moiety for every 100 mole weight of the polymer. A preferred hydrophilic polymer is polyester phthalate.

The printing face according to the invention may advantageously include one or more elastomeric rubbers; one or more additives and/or processing aids; a crosslinking agent; and one or more antioxidants.

In a preferred embodiment, the one or more elastomeric rubbers comprises at least one nitrile rubber copolymer having an acrylonitrile content from about 25% to about 41%, preferably from about 35% to about 40%. In this preferred embodiment, the at least one nitrile rubber copolymer possesses an average acrylonitrile content from about 36% to about 40%. One preferred nitrile rubber copolymer includes butadiene monomers, as well as acrylonitrile monomers, and optionally, but less preferably a few percent of one or more other comonomers. Preferably, the butadiene content of the nitrile rubber copolymer is at least about 55%, preferably at least about 59%, more preferably from about 59% to about 61%. The elastomeric rubber may contain a mixture of rubber homopolymers or copolymers containing acrylonitrile monomers, and preferably contains at least about 50%, more preferably at least about 80%, most preferably at least about 90%, of the acrylonitrile-butadiene copolymer.

In one embodiment, the elastomeric rubber component comprises a mixture of nitrile rubbers. In another embodiment, the acrylonitrile content of the at least one nitrile rubber copolymer can be from about 30% to about 37%, or the average acrylonitrile content of all the included nitrile rubber copolymers can be from about 33% to about 37%. In still another embodiment, the one or more elastomeric rubbers does not include a polysulfide.

In addition to about 100 parts rubber, a adhesive layer composition according to the invention may preferably comprise: crosslinking agents present in an amount from about 5 to about 35 pph rubber, preferably from about 8 to about 25 pph rubber, more preferably from about 10 to about 20 pph rubber; one or more antioxidants present in an amount not more than about 15 pph rubber, preferably from about 0.5 to about 10 pph rubber, more preferably from about 1 to about 8 pph rubber; and additives and/or processing aids present in an amount not more than about 120 pph rubber, preferably from about 20 to about 110 pph rubber, more preferably from about 40 to about 100 pph rubber, most preferably from about 55 to about 95 pph rubber.

In these preferred embodiments, the adhesive layer composition according to the present invention may possess one or more of the following: a silica content from about 12 to about 30 pph rubber; a retarding agent content from about 0.5 to about 4 pph rubber; a resin content from about 2 to about 10 pph rubber; a non-vulcanized oil content from about 10 to about 30 pph rubber; a factice content from about 10 to about 30 pph rubber; an organosilane content from about 1 to about 5 pph rubber; a pigment content from about 5 to about 25 pph rubber; a hydroquinoline content from about 0.1 to about 3 pph rubber; a zinc 2-mercapto-toluimidazole content from about content from about 0.1 to about 3 pph rubber; a phenylenediamine content from about 0.5 to about 3 pph rubber; a sulfur donor content from about 1 to about 4 pph rubber; an accelerator content from about 0.1 to about 3 pph rubber; a sulfur content from about 0.5 to about 3 pph rubber; a stearic acid content from about 0.5 to about 4 pph rubber; an activator content from about 5 to about 15 pph rubber; and/or a combination thereof.

In other embodiments, a printing face composition according to the present invention may comprise: crosslinking agents present in an amount from about 5 to about 35 pph rubber, preferably from about 8 to about 25 pph rubber, more preferably from about 8 to about 20 pph rubber; one or more antioxidants present in an amount not more than about 10 pph rubber, preferably from about 0.1 to about 5 pph rubber, more preferably from about 0.5 to about 3 pph rubber; and additives and/or processing aids present in an amount not more than about 85 pph rubber, preferably from about 15 to about 75 pph rubber, more preferably from about 25 to about 70 pph rubber, most preferably from about 30 to about 65 pph rubber.

In these other embodiments, the printing face composition according to the present invention may preferably possess one or more of the following: from about 20 to about 40 parts of a polysulfide component; from about 5 to about 20 pph of silica; from about 10 to about 30 pph of a factice; from about 0.1 to about 5 pph of a phenolic antioxidant; from about 3 to about 12 pph of pigment; from about 1 to about 10 pph of an accelerator; from about 4 to about 10 pph of a non-vulcanized oil; from about 0.1 to 1.5 pph of a retarding agent; from about 0.1 to 3 pph of stearic acid; from about 3 to about 15 pph of an activator; and/or a combination thereof.

In another preferred embodiment, the one or more additives and/or processing aids includes a factice, at least one pigment, a retarding agent, an inorganic filler, or a combination thereof.

A second aspect of the invention is the hydrophilicity (water loving), polarity and basicity of the cured composition. These are the surface chemistry issues which compatiblize the blanket to the ink/fountain solution combination. Ink is typically acidic, as gum arabic, a common component of ink, requires an acidic pH, i.e., near 4, to be stable. These characteristics are obtained via goniometric analysis of the surface chemistry using target liquids of known surface energy. The hydrophilicity obtains contact angles on deionized water of 40 to 90 degrees, preferred 50-80 degrees, more preferred 60-70 degrees. The contact angle to a base is preferably between about 40 to 70 degrees, preferably between about 50 to 60 degrees. The contact angle to acid is preferably 5 to 20 degrees. The acid-base interaction and polarity can be expressed in terms of components using three liquids, (methylene iodide, or bromonaphthalene, for the apolar liquid and glycerol and formamide for the polar. The mathematical calculations which derive these components can be purchased via hardware/software combinations obtained at Rame'-Hart or AST Products, Inc.

Another aspect of the invention is rapid state of cure development. The advantage over prior art is lower compression set as defined by ASTM methods D395. The invention can be designed to possess D395 set of 50-0%, preferred 40-10%, more preferred 30-15% compression. The more preferred dynamic Compression Set is obtained via ASTM D623 from the Goodrich Flexometer. The same values are used as in ASTM D395 however these are obtained under dynamic stress/strain conditions under operation temperature environment. This translates into better heat resistance.

Another aspect of the invention is low absorbency of hydrocarbons, for example toluene. Typical hydrocarbon swells at 20 minutes are observed at 30 to 50%, which are lower than swells in the prior art chemistry. Advantageously, weight gain on a quarter-shaped button when immersed in toluene is less than 15%, preferably less than 10%, for 10 minutes, preferably less than 30% for 20 minutes, and preferably less than 50%, more preferably less than 40%, when immersed for 60 minutes.

Another aspect of the invention is higher tear and cut strength. The polysulfide-based composition of the prior art had poor mechanical strength. The advantage over prior art is better life on the press, fewer paper cuts, and face damage from smashes and paper wrapping. Advantageously, the printing face layer has a tensile strength greater than about 600 psi, preferably greater than about 1000 psi, and the elongation at break is greater than 250%, preferably greater than 400%.

Another aspect of the invention is elimination of THIOKOL polysulfide. This raw material is in short supply, causing shortages. This material has inferior dynamic properties than Nitrile.

The strength of the rubber composition is such that it is amenable for providing threadless printing blankets. The threadless printing blanket for the gapless seamless printing blanket market includes a plurality of layers, including a substantially cylindrical sleeve, a threadless compressible layer or cushion layer, optionally a threadless reinforcing layer, and a threadless printing face layer. Threads are believed to affect print quality and create undesired pressure lines in the printing face, which transfers the ink to paper at variations in intensities. A threadless blanket would be an improvement over current and prior art for print quality.

In one embodiment, the blanket contains a high modulus/low elongation sleeve. This sleeve is typically a thin 0.003″ to 0.010″ nickel alloy sleeve that has been primed with one or two primers which promote adhesion of the compressible layer onto the sleeve. This invention is not limited to metallic sleeves, however, and can be applied to ant suitable high modulus/low elongation film type substrates of non-metallic and metallic structure.

It is recognized that the cured printing blanket will contain substantially no solvent, and few if any of the polymeric compounds. The compositions and solvent concentrations are expressed as what would be found when the composition is applied to the printing blanket, before drying, curing, and vulcanization.

### EXAMPLES

Both compressible layers and printing face layers were manufactured according to a preferred embodiment of this invention. The data are presented in Table 1 for compressible layers, and in Table 2 for the printing face compositions of Examples 2-3 and a comparative example. The data in Table 3 represents the printing face composition of Example 3.

TABLE 1

| | Comparative | Comparative | |
|---|---|---|---|
| Compressible Layer | Example 1 | Example 2 | Example 1 |
| Hardness (Shore A) | 53 | 63 | 54 |
| 300% Modulus (MPa) | 5.25 | 6.7 | 10.75 |
| Tensile (MPa) | 6.29 | 6.7 | 17.1 |
| Elongation (%) | 370 | 300 | 396 |
| Tear (N/mm) | 21.6 | 24.3 | 31.7 |
| Comp Set (%) | 8 | 7 | 7 |

The formulation in Table 1 gives significantly greater resistance to wear and tear, is still soft enough to provide acceptable print quality, and has excellent resistance to solvents, oils, and dyes.

TABLE 2

| | Comparative | | |
|---|---|---|---|
| Printing Face | Example 3 | Example 2 | Example 3 |
| Hardness (Shore A) | 44 | 64 | 50 |
| 300% Modulus (MPa) | 3.06 | 6.31 | 4 |
| Tensile (MPa) | 3.52 | 13.3 | 8 |
| Elongation (%) | 332 | 406 | 500 |
| Tear (N/mm) | 9.9 | 30.9 | 25 |
| Comp Set (%) | 80 | 30 | 40 |

TABLE 3

| Comp. Layer: Compound | Tradename | Parts by weight |
|---|---|---|
| 41% acrylonitrile nitrile rubber | Zeon 1031 or NITRIFLEX N386B | 100 |
| Reinforcing silica (pH is 9-11) | Degussa DURASIL 880 | 20 |
| Organosilane coupling agent | Degussa Silane Si69 | 3 |
| Processor | AKROCHEM P-87 | 5 |
| Factice-crosslinked veg. Oil | RHENOPRENE EPS | 20 |
| Hydrophilic terephthalate-based oil | CP Hall PLASTHALL P-900 | 20 |
| Metal (magnesium) oxide | CP Hall MAGLITE K | 3 |
| Antioxidant | Akrochem DQ or RESIN D | 1 |
| Antioxidant | ZMTI | 1 |
| pigment | 12973 Blue pigment | 4 |
| Metal oxide (80% TiO2) | | 1 |
| Antiozonant | Akrochem PD-2 or 6PPD | 2 |
| 2nd Pass Cure | | |
| Dithiodimorpholine (primary accel) | SULFASAN R | 2 |
| Thiuram (secondary accel) | TETD | 0.5 |
| Spider Sulfur | | 1.5 |
| Zinc Oxide | | 5 |
| Stearic Acid | | 2 |
| Solvent | Ketones, aromatics, mixtures thereof (as needed) | |
| Microcells | | 4-6 |

These formulations can be prepared by one of ordinary skill in the art without premature crosslinking and the like by, for example, preparing master-batches where non-active agents are pre-homogenized. Additionally, the compressible layer of Example 1 has about 1 - 10, typically between 4 and 6% by weight of elastomeric and/or thermoset microcells, in expanded or unexpanded condition. Said microcells are typically added along with or after the addition of sufficient solvent to allow flow coating, extrusion, spray coating, or thread coating (applying elastomer via elastomer-loaded thread wound around the blanket).

The composition of the printing face layer of Example 2 is delineated in the table 4 below. Notably, this printing face contains polysulfide, which provides resistance against oils and solvents but which may weaken the face. The NIPOL VT rubbers are copolymers of acrylonitrile and butadiene, each having a Mooney viscosity of approximately 80. The composition of the 380 rubber is approximately 30/70 acrylonitrile/butadiene; the composition of the 480 rubber is approximately 40/60 acrylonitrile/butadiene; and the composition of the 3380 rubber is approximately 33/67 acrylonitrile/butadiene.

TABLE 4
POLYSULFIDE-CONTAINING PRINTING FACE

| INDIVIDUAL COMPONENTS | Parts by weight |
|---|---|
| NIPOL VT380 nitrile rubber | From about 10 to about 20 parts |
| NIPOL VT480 nitrile rubber | From about 10 to about 20 parts |
| NIPOL DN3380 nitrile rubber | From about 25 to about 50 parts |
| THIOKOL Polysulfide | From about 15 to about 45 parts |
| HISIL 233 silica | From about 2 to about 30 parts |
| RHENOPRENE C crosslinked vegetable oil | From about 5 to about 40 parts |
| Stearic Acid | Not more than about 5 parts |
| NAUGA WHITE bis-phenol | Not more than about 10 parts |
| RHENOGRAN ZNO-85 (85% ZnO TIN EPR) | From about 1 to about 20 parts |
| Phthalimide | Not more than about 2 parts |
| POLY-DISPERSION A(TI)D-80 (80% TIO2 IN NBR) | Not more than about 10 parts |
| 12973 Blue pigment | From about 0.5 to about 10 parts |
| RHENOGRAN MBTS-75 (75% sulfenamide IN EPR) | From about 0.5 to about 10 parts |
| tetramethylthiuram | From about 0.5 to about 5 parts |
| di(butoxy-ethoxy-ethyl)formal oil | From about 2 to about 15 parts |

The ingredients above were combined using a BANBURY and an open mill mixer. Temperature, mixing strength, and order of addition of ingredients was controlled so that the composition was homogenized but such that there was substantially no interference with fabrication of the compressible layer via premature activation of the crosslinking or vulcanization reaction.

Printing blankets were also fabricated incorporating the printing face layer of Example 2. This was accomplished by extruding the composition and disposing the composition over a compressible layer, or optionally over an adhesive layer that is disposed upon a reinforcing layer and/or the compressible layer. In another embodiment, the later is electrostatically sprayed over the compressible layer. Preferably, a special adhesive is placed between the layers.

The composition of the printing face layer of Example 3 is delineated in the table 5 below. NIPOL 4050 is a copolymer containing approximately 40% acrylonitrile and about 60% butadiene.

TABLE 5
PRINTING FACE FORMULATION

| | EXAMPLE 3 | COMPONENT RANGES |
|---|---|---|
| INGREDIENT | (PPH RUBBER) | (PPH RUBBER) |
| NIPOL 4050 nitrile rubber | 100 | About 100 parts |
| DURASIL 880 Silica | 20 | From about 5 to about 50 |
| DEGUSSA SI-69 organosilane | 3 | From about 0.5 to about 6 |
| AKROCHEM P-87 phenol | 5 | From about 2 to about 10 |
| formaldehyde resin | | |
| RHENOPRENE BPS crosslinked veg. oil | 20 | From about 5 to about 4 |
| PLASTHALL P-900 polyester phthalate oil | 20 | From about 5 to about 35 |
| MAGLITE K (magnesium oxide) | 3 | Not more than about 10 |
| AKROCHEM DQ (hydroquinoline) | 1 | Not more than about 5 |
| VANOX ZMTI (zinc 2-mercapto-toluimidazole) | 1 | Not more than about 5 |
| HARWICK 12973 Blue pigment | 4 | From about 0.5 to about 10 |
| POLYMERICS 80% TiO2 White pigment | 10 | From about 2 to about 25 |
| Phenylenediamine | 2 | Not more than about 5 |
| Dithiodimorpholine | 2 | From about 1 to about 5 |
| Tetraethylthiuram | 0.5 | From about 0.25 to about 4 |
| Phthalimide | 2 | Not more than about 2 |
| AKROCHEM P-80 sulfur (80% sulfur in SBR) | 1.5 | From about 0.5 to about 3 |
| Stearic Acid | 2 | From about 0.5 to about 4 |
| Zinc Oxide (85% KENRICH French Process) | 5 | From about 2.5 to about 40 |

It is of course recognized by one of skill in the art that while the ranges given in the table for Example 3 are for specific compounds, these ranges also apply to the general class of compounds in which the respective compounds exist. The ingredients above were combined using a BANBURY mixer. Temperature, mixing strength, and order of addition of ingredients was controlled so that the composition was homogenized but such that there was substantially no interference with fabrication of the compressible layer via premature activation of the crosslinking or vulcanization reaction.

Increased hydrophilicity can be advantageous in printing faces of the invention. The printing face of Example 3 shows more hydrophilic character than the printing face described in Example 2. Without being bound to theory, it is surmised that the addition of the polyester phthalate oil and the magnesium oxide co-accelerator result in the increased hydrophilicity of the composition in Example 3.

### Example 4

### Optional Adhesive Layer Composition According to the Invention

It is noted that the compressible layer is often at least partially vulcanized prior to applying the printing face layer. It is on occasion a problem that one layer may as a result delaminate from the other layer. The adhesive layer composition according to the invention may advantageously include about 100 parts of one or more elastomeric rubbers; one or more additives and/or processing aids; a crosslinking agent; and one or more antioxidants.

In a preferred embodiment, the one or more elastomeric rubbers comprises at least one nitrile rubber copolymer having an acrylonitrile content from about 25% to about 41%, preferably from about 30% to about 35%. In this preferred embodiment, the at least one nitrile rubber copolymer possesses an average acrylonitrile content from about 30% to about 35%. One preferred nitrile rubber copolymer includes butadiene monomers, as well as acrylonitrile monomers, and optionally, but less preferably a few percent of one or more other comonomers. Preferably, the butadiene content of the nitrile rubber copolymer is at least about 60%, preferably at least about 65%, more preferably from about 66% to about 68%. The elastomeric rubber may contain a mixture of rubber homopolymers or copolymers containing acrylonitrile monomers, and preferably contains at least about 50%, more preferably at least about 80%, most preferably at least about 90%, of the acrylonitrile-butadiene copolymer.

In addition to about 100 parts rubber, an adhesive layer composition according to the present invention may preferably comprise: crosslinking agents present in an amount from about 2 to about 30 pph rubber, preferably from about 4 to about 25 pph rubber, more preferably from about 6 to about 20 pph rubber; one or more antioxidants present in an amount not more than about 10 pph rubber, preferably from about 0.1 to about 8 pph rubber, more preferably from about 0.5 to about 6 pph rubber; and additives and/or processing aids present in an amount not more than about 95 pph rubber, preferably from about 15 to about 90 pph rubber, more preferably from about 25 to about 85 pph rubber, most preferably from about 35 to about 80 pph rubber.

In preferred embodiments, the adhesive layer composition according to the present invention may possess one or more of the following: a silica content from about 20 to about 55 pph rubber; a non-vulcanized oil content from about 10 to about 30 pph rubber; an organosilane content from about 0.5 to about 3 pph rubber; a pigment content from about 3 to about 20 pph rubber; a bis-phenol content from about 0.5 to about 6 pph rubber; an accelerator content from about 1 to about 10 pph rubber; a sulfur content from about 0.5 to about 4 pph rubber; an activator content from about 2 to about 12 pph rubber; and/or a combination thereof.

In one embodiment, an adhesive layer according to the invention is disposed between the printing face and the compressible layer. In another embodiment, the adhesive layer may advantageously function as an adhesive or compatibilizer for the printing face and the compressible layer.

In a preferred embodiment, the one or more elastomeric rubbers comprises at least one nitrile rubber copolymer having an acrylonitrile content from about 25% to about 41%, preferably from about 30% to about 37%. In this preferred embodiment, the at least one nitrile rubber copolymer possesses an average acrylonitrile content from about 30% to about 37%.

Printing blankets were also fabricated incorporating the printing face layer of Example 3. Similarly to that described in Example 2, this was accomplished by extruding or electrostatically spraying the composition over a compressible layer, or optionally over an adhesive layer that is disposed upon a reinforcing layer and/or the compressible layer.

### Example 5

### Tests of Printing Blanket According to the Invention

In the printing industry that there are many factors that enter into the utility of a printing blanket. In addition to the basic properties of the layers, the blanket must have the appropriate acidity and wettability, the required stiffness but also the required compressibility, and the layer formulations must not creep or show signs of age while in operation. During typical operation, a blanket is expanded and placed on a roller, rotated at a high velocity while being coated with different ink formulations while compressing against both paper and other rollers, nips, and the like, and must be able to survive impacts when multiple pieces of printing substrate, i.e., paper, are accidently jammed in the small tolerances between the blanket and the roller. As a result, no printing blanket formulations can be considered useful unless they have been tested on a printer. Printing blankets using the formulations of example 1 for the compressible layer, example 4 for the adhesive, and either example 2 or example 3 for the printing face, were prepared using electrostatic-spray-on technology. These sleeves have no threads, and in one embodiment are manufactured by

providing a primed nickel sleeve;

electrostatic spraying on the compressible layer onto the nickel sleeve;

at least partially vulcanizing the compressible layer;

optionally grinding the compressible layer;

applying the adhesive over at least partially vulcanized compressible layer;

electrostatic spraying of the printing face formulary of either example 2 or example 3;

vulcanizing the rubbers in the sleeve; and

grinding the printing face to a tolerance of about 1 micron.

Some of the sleeves were prepared by extruding at least one layer rather than electrostatically spraying the layer.

The tests were Four-Color Catalogs printed on a SUNDAY PRESS TM available from Heidelberger Druckmaschinen AG, Heidelberg, DE. A four color test is a rigorous test as multiple rollers must act in concert to provide acceptable registration as the printing substrate passes from one roller to the next. In these tests, there was no Process Color in Unit #1, Black was in Unit #2. A print run was started with commercially available sleeves which were run for about 350M impressions. The print operating data from the prior art commercial sleeves is shown in Table 6.

TABLE 6

| | | | Temperature | |
|---|---|---|---|---|
| | Unit | Compliancy | Oper. | Gear |
| Com. 1 | #2 - Upper Black | 42 | 90 | 92 |
| Com. 2 | #2 - Lower Black | 42 | 95 | 92 |
| Com. 3 | #3 - Upper Cyan | 40 | 95 | 96 |
| Com. 4 | #3 - Lower Cyan | 40 | 95 | 96 |
| Com. 5 | #4 - Up. Magenta | 41 | 95 | 97 |
| Com. 6 | #4 - Lo. Magenta | 41 | 96 | 99 |
| Com. 7 | #5 - Upper Yellow | 43 | 98 | 97 |
| Com. 8 | #5 - Lower Yellow | 43 | 98 | 99 |

The sleeves of this invention, which contained no threads and the printing face formulary of example 2, were then installed. Printing was within 0.020″ on register and color looked good, and after warmup of about 2,000 sheets the print was of commercial quality.

The water was reduced and the print quality improved marginally. These sleeves were consumed after 1 -1.5 million impressions.

In the next test, the sleeves were gradually replaced with the sleeves from the printing face formulary of example 3, of this invention. A second catalog was printed, again with 4 colors. The color of commercial quality, but after about 400,000 impressions three of the sleeves were pulled. Two had pinholes or blisters and one had ink piling.

These three sleeves were replaced with those of Example 3. Ultimately one was on the black unit and two were on the Magenta unit. The register and color were fine and no noticeable difference was observed by the Press Crew. The sleeves ran 0.9 million impressions.

The printing face formulary of example 2 has a tensile strength less than 1000 psi. The tensile strength of the printing face formulary of example 3 is greater than 1000 psi but less than 6000 psi tensile values.

All Experimental sleeves went on easy, without need of lubricant. The tests were run at 1400 to 2700 feet per hour, and 14000-88000 impressions per hour. Table 7 describes the print operating data for the Sleeves with printing face formulary of example 2 that replaced the commercial sleeves listed above, when run at 2400 feet per hour and 78000 impressions per hour, where Id. is an identification number.

TABLE 7

| | | Temperature | |
|---|---|---|---|
| I.D. | Unit | Oper. | Gear |
| 6044 | #2 - Upper Black | 98 | 99 |
| 6670 | #2 - Lower Black | 97 | 100 |
| 9432 | #3 - Lower Cyan | 101 | 100 |
| 9410 | #3 - Upper Cyan | 99 | 97 |
| 6835 | #4 - Lower Magenta | 102 | 98 |
| 9436 | #4 - Upper Magenta | 103 | 100 |
| 4447 | #5 - Upper Yellow | 100 | 101 |
| 6675 | #5 - Lower Yellow | 102 | 101 |

The temperature is recorded because it is desirable to control both gear and opeating temperatures within prescribed limits. The blankets must not generate excessive heat during operation, and must be able to dissipate the heat generated.

No Bustle wheels were needed and the sheet looked good. The operators mentioned that they have problems printing wide webs >52″ with commercial sleeves, where the registration on the ends varies from the rest of the sleeve on wide webs. At the time this was checked there were 500M impressions on the plates and the problem was not observed with the experimental sleeves. The printing was done on 50 weight paper DESPERADO™ Web Paper from Mead. The print job was a Catalog that was 44½″ wide.

We have surprisingly found that the thicker compressible layer and the relatively lower compliancy of the composition allow the locust of many points to act as independent springs. On a 57″ long sleeve, it is estimated that the core deflects between 0.003-0.004″ from the center to the ends during high speed operation. The center deflects more than the ends. In a traditional sleeve of the prior art, to compensate for the deflection, the ends are step ground or profiled. The sleeve of the prior art includes wound inextensible thread layer that require the step grind. The new sleeves of this invention contain no such inextensible layer, that is, the nickel is inextensible but the compressible layer and the face later are 100% elastomeric. Elastomers with a 50-60 Shore A hardness. are elastic by definition. The compressible layer formulations contain 4.5% & 5.5% by weight microspheres. The range of microspheres is 1-7% with the preferred being 2.5-6.0% and most preferred being 5.0-5.5%. Though these sleeves had a profiled grind of a layer, sleeves of this invention in some embodiments have been surprisingly found to not need profile grinding. The following data was obtained with sleeves of at 2407 feet per hour.

| | | Temperature (F) | | |
|---|---|---|---|---|
| Sleeve ID | Unit | Oper. | Gear | Comments |
| 6044 | #2 - Upper Black | 97 | 97 | Job running smooth |
| 6670 | #2 - Lower Black | 98 | 101 | 90,000 impressions |
| 6816 | #3 - Upper Cyan | 97 | 100 | |
| 9432 | #3 - Lower Cyan | 101 | 100 | |
| 9436 | #4 - Upper Magenta | 103 | 101 | |
| 9435 | #4 - Lower Magenta | 103 | 104 | |
| 6675 | #5 - Upper Yellow | 103 | 102 | |
| 4447 | #5 - Lower Yellow | 101 | 103 | |

The speed of the press was increased to 2503 ft/hr. (81,000 impressions/hour) and the following temperature data was obtained after 205,000 impressions and after temperature was increased 2° F. and then brought back down after 292,000 net impressions were made.

| | | | | Temperature @ | |
|---|---|---|---|---|---|
| Sleeve ID | Unit | Temperature | | 292,000 impressions | |
| 6044 | #2 - Upper Black | 100 | 100 | 96 | 96 |
| 6670 | #2 - Lower Black | 103 | 100 | 96 | 97 |
| 6816 | #3 - Upper Cyan | 98 | 101 | 98 | 99 |
| 9432 | #3 - Lower Cyan | 101 | 101 | 99 | 104 |
| 9436 | #4 - Upper Magenta | 105 | 101 | 105 | 100 |
| 9435 | #4 - Lower Magenta | 102 | 104 | 100 | 100 |
| 6675 | #5 - Upper Yellow | 104 | 101 | 104 | 100 |
| 4447 | #5 - Lower Yellow | 101 | 104 | 102 | 103 |

At 379M impressions the temperature remained fairly stable and washup was easy. At 500 M impressions the #2—Upper Black sleeve blew out, and shortly thereafter the #4—Upper Magenta and #4—Lower Magenta sleeves were replaced due to pin holes. The sleeves reached 125 degrees F. after removal from the press. There was a slight registration problem after these sleeves were replaced with sleeves from the printing face formulary of Example 3, but the quality was soon commercially acceptable. The operating temperature at 2100 feet per hour (68,000 impressions per hour) were:

| | | |
|---|---|---|
| Sleeve ID | Unit | Temperature |

| | | | |
|---|---|---|---|
| 9441 | #2 - Upper Black | 92 | 91 |
| 6670 | #2 - Lower Black | 93 | 94 |
| 6810 | #3 - Upper Cyan | 95 | 97 |
| 9432 | #3 - Lower Cyan | 95 | 98 |
| 157 EXP-350 | #4 - Upper Magenta | 99 | 96 |
| 021 EXP-350 | #4 - Lower Magenta | 96 | 97 |
| 6675 | #5 - Upper Yellow | 100 | 97 |
| 4447 | #5 - Lower Yellow | 96 | 100 |

With these sleeves in place a new 4-color Catalog job was started using a 38# paper Drapers Gloss™ and a 46¼″ wide web. The 9441 sleeve was damaged during transition and was replaced. Operating conditions were:

| | | |
|---|---|---|
| Sleeve ID | Unit | Temperature |

| | | | |
|---|---|---|---|
| 9443 | #2 - Upper Black | 105 | 96 |
| 6670 | #2 - Lower Black | 109 | 106 |
| 6810 | #3 - Upper Cyan | 106 | 105 |
| 9432 | #3 - Lower Cyan | 112 | 105 |
| 157-EXP-350 | #4 - Upper Magenta | 110 | 106 |
| 021-EXP-350 | #4 - Lower Magenta | 96 | 95 |
| 6675 | #5 - Upper Yellow | 95 | 94 |
| 4447 | #5 - Lower Yellow | 91 | 95 |

At 247,000 impressions, the unit continued to run without problems, and operating temperatures were between 93° F. and 101° F., generally increasing as the unit increased. The #4—Lower Magenta gear was running at 103° F., about 4° hotter than the operating temperature. The remaining gear temperatures were within 2° F. of the operating temperatures. Soon thereafter, several sleeves blistered and were replaced.

About 2,000,000 impressions were accumulated on the sleeves of Example 3 and the other sleeves of this invention. The print was judged to be of commercial quality and the electrostatically sprayed, no-thread sleeves of this invention were interchangeable with commercial threaded blankets.

The printing blankets with the elastomeric compositions described above and in the claims are considerably stronger than the prior art blankets. As such, the strength of wound threads which were used in the prior art to apply the compressible layer and often the printing layer, is not needed. The threads provided a substantially inelastic layer. The modulus of elasticity can be made high enough such that a reinforcing layer of threads is not needed. A preferred embodiment comprises at least one layer that has a modulus of elasticity that is between about 100 pounds per square inch and 2000 pounds per square inch, preferably between about 500 pounds per square inch and about 950 pounds per square inch, more preferably between about 700 pounds per square inch and about 900 pounds per square inch. Preferably, this layer is between about 0.006 inches and 0.047 inches in thickness. This provides strength while not giving a layer that is substantially inelastic. Inelastic layers incorporated into a cylindrical printing blanket may be responsibe for standing waves being forms at the entrance where the blanket contacts a roller.

In another embodiment, a reinforcing layer can be disposed between the compressible layer and the printing face layer. This layer may be of an elastomer composition of the printing face layer or of the compressible face layer, but with added crosslinking agents, for example up to twice the curing and crosslinking agents specified for the printing face layer or of the compressible face layer, respectively.

In another embodiment, a reinforcing layer can be a film with a modulus of elasticity of between about 1000 pounds per square inch and about 20000 pounds per square inch, preferably between about 11000 pounds per square inch and about 16000 pounds per square inch. High strength ribbons of this low elasticity film can be wound in a barber pole fashion around the printing blanket, and can be adhered to the sleeve and/or to the elastomeric layer(s) by for example an adhesive described herein. An elastomeric product may already be put on the substantially inelastic film prior to winding the film onto the substrate. This elastomeric product, preferably a printing face formulation or a compressible layer formulation with or without microcells, may be in a cured state, a partially cured but tacky state, or a substantially uncured state which may include residual solvents. The elastomeric material is beneficially facing outward so that any subsequent grinding will not affect the integrity of the film. A preferred film comprises at least one of MYLAR (TM), ARAMID (TM), KEVLAR (TM), high density polyethylene, polyester, or other film-forming polymers with high modulus/low elongation properties known in the art.

The preferred polymeric sleeve comprises one or more layers of MYLAR. The polymeric sleeve may be made by extrusion, by winding, or by a combination thereof. The polymeric sleeve may have reinforcing materials embedded therein, ir may be self-reinforced by stretching the blanket to partially orient the polymeric molecules. Said stretching can be performed at a temperature above or below the glass transition temperature.

In one embodiment sleeves that were 0.005 inches, 0.010 inches, and 0.020 inches in thickness were tested. The thickness of the polymeric sleeve in one embodiment is between about 0.004 inches and 0.28 inches, preferably between about 0.1 inches and 0.20 inches. The use of the higher strength polymeric materials described herein, which optionally includes a reinforcing layer, provides sufficient strength to the blanket that these thinner polymeric sleeves can be used.

The inner layer, the outer layer, or both of the sleeve may be treated to increase friction, reduce squealing noise, or increase adherence of other layers. The sleeve may be metal or polymeric.

We claim:

1. A printing blanket comprising:
a sleeve;
a compressible layer including a open or closed-cell polymeric foam; and
a printing face layer, wherein the printing face layer comprises:
a base of 100 parts of an acrylonitrile-containing polymer with between about 35% to about 50% by weight acrylonitrile content copolymerized with butadiene;
about 5 to about 50 pph of silica;
about 0.1 to about 15 pph of a coupling agent;
about 5 to about 60 pph of a processing oil;
at least about 0.1 pph of a sulfur-based curing agent;
about 1 to 10 pph zinc oxide; and
about 1 to about 20 pph metal oxide wherein the metal oxide comprises TiO2, MgO, CaO, or a mixture thereof.

2. The printing blanket of claim 1 further comprising between about 1 to about 10 pph of a fatty acid, wherein the processing oil comprises polyester phthalate and the nitrile comprises 36% to about 45 % by weight acrylonitrile copolymerized with butadiene.

3. The printing blanket of claim 1 wherein the silica when admixed with an equal volume of deionized water imparts a pH of between about 9 to about 11 to the water, and wherein the quantity of silica is between about 15 pph to about 25 pph..

4. The printing blanket of claim 1 wherein the acrylonitrile-containing polymer is a random acrylonitrile butadiene copolymer that contains between about 3 9% to about 41% by weight acrylonitrile content, and wherein the coupling agent comprises an organosilane compound.

5. The printing blanket of claim 1 wherein the processing oil is present in an amount between about 15 to about 25 pph and wherein the coupling agent is present in an amount between about 3 to about 5 pph.

6. The printing blanket of claim 1 wherein the sulfur-based curing agent comprises between about 0.1 to about 3 pph of sulfur, between about 0.1 to about 4 pph of a primary accelerator, and between about 0.1 to about 3 pph of a secondary accelerator.

7. The printing blanket of claim 2 wherein the total quantity of zinc oxide and fatty acid or salt thereof is between about 5 to about 8 pph.

8. The printing blanket of claim 1 further comprising in the printing layer between about 1 pph to about 8 pph of an antioxidant, an antiozonant, or a mixture thereof.

9. The printing blanket of claim 1 further comprising between about 0.1 pph to about 20 pph of a halogenated compound in the printing layer.

10. The printing blanket of claim 9 wherein the halogenated compound comprises a fluorosurfactant in an amount sufficient to increase the hydrophilicity of the printing layer.

11. The printing blanket of claim 1 wherein the printing face layer swells less than about 40% when immersed in toluene for 60 minutes at ambient conditions, has a tensile strength greater than about 600 psi, and the elongation at break is greater than 250%.

12. The printing blanket of claim 1 wherein the printing face layer has a tensile strength greater than about 1000 psi and the elongation at break is greater than 300%.

13. The printing blanket of claim 1 wherein the compressible layer and the printing layer are substantially free of wound thread in the printing area.

14. The printing blanket of claim 1 wherein the compressible layer comprises a nitrile-butadiene copolymer, hydrogenated nitrile-butadiene copolymer, carboxylated nitrile-butadiene copolymer, nitrile-butadiene- isoprene terpolymer, neoprene, isoprene, epoxidized isoprene, or a mixture thereof;
an aromatic oil at a rate of between about 5 pph and 30 pph;
carbon black; and
a sulfur-based curing agent.

15. A printing blanket comprising:
a sleeve;
a compressible layer including a open or closed-cell polymeric foam; and
a printing face layer, wherein the printing face layer comprises:
a base of 100 parts of nitrile rubber with between about 36% to about 45% by weight acrylonitrile copolymerized with at least butadiene;
a particulate filler at between about 5 pph to about 50 pph;
a coupling agent at a quantity of between about 0.5 to about 6 pph, wherein the coupling agent increases the surface adhesion of the particulate filler to the rubber;
a hydrophillic polymer with a molecular weight of at least about 400 and with at least one hydroxyl moiety per 100 molecular weight at between about 5 to about 35 pph;
a factice at about 5 to about 40 pph;
sulfur at about 0.5 to about 3 pph;
a primary accelerator at about 0.1 to about 4 pph;
zinc oxide at between about 2.5 to about 30 pph; and
a metal oxide selected from the group consisting of TiO₂, MgO, and/or CaO, at between about 1 to about 10 pph; wherein the composition is vulcanized to form the printing face layer.

16. The printing blanket of claim 15 wherein the printing face layer further comprises at least one of a wood rosin or a phenol formaldehyde resin at from about 2 to about 10 pph, and wherein the particulate filler comprises silica.

17. The printing blanket of claim 15 wherein the printing layer further comprises a retarder, and the particulate filler comprises carbon black.

18. A printing blanket comprising:
a sleeve;
a compressible layer including a open or closed-cell polymeric foam; and
a printing face layer, wherein the printing face layer comprises:
about 100 parts of nitrile rubber with an average acrylonitrile content from about 36% to about 40% by weight;
from about 5 to about 50 parts silica;
from about 0.5 to about 6 of an organosilane;
from about 2 to about 10 parts of a tackifying resin;
from about 5 to about 40 parts of a crosslinked vegetable oil
from about 5 to about 35 parts of a hydrophillic polymer;
from about 2.5 to about 30 parts of a metal oxide;
from about 0.5 to about 4 parts of a fatty acid; and
from about 0.5 to about 3 parts sulfur.

19. The printing blanket of claim 15 wherein the blanket is substantially free of polysulfide polymer, and wherein the tensile strength of greater than 1000 pounds per square inch.

20. A printing blanket comprising:
a sleeve;
a compressible layer including a open or closed-cell polymeric foam; and
a printing face layer, wherein the printing face layer comprises:
a base of 100 parts of nitrile rubber with between 38% to about 45% by weight acrylonitrile;
a particulate filler at between about 5 pph to about 50 pph;
a coupling agent at a quantity of between about 0.5 to about 6 pph;
at least one wettability modifier in an amount sufficient to increase the hydrophilicity of the printing face layer;
a factice at about 5 to about 40 pph;
sulfur at about 0.5 to about 3 pph;
a primary accelerator at about 0.1 to about 4 pph;
from about 0.5 to about 4 parts of a fatty acid; and
zinc oxide at between about 2.5 to about 30 pph; wherein the composition is vulcanized to form the printing face layer.
